(19) United States
(12) Patent Application Publication
(10) Pub. No.: US 2009/0076421 A1
(43) Pub. Date: Mar. 19, 2009

(54) Frequency Stimulation Trainer

(76) Inventor: Thomas E. Grant, JR., Alpine, UT (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/920,333

(22) PCT Filed: May 11, 2006
(86) PCT No.: PCT/US2006/018378

§ 371 Date: Nov. 8, 2007

Related U.S. Application Data
(60) Provisional application No. 60/679,865, filed on May 12, 2005.

(51) Int. Cl. A61H 1/00

(52) U.S. Cl. 601/47; 601/46

(57) ABSTRACT

A preferably non-electrical nerve communication enhancement tool that sends specific, pre-timed, controlled vibrational and/or acoustical stimulation frequencies to the body to enhance nerve communication for the purpose of assisting in proper function of skeletal muscle, smooth muscle, sympathetic and parasympathetic nervous systems, and facilitating rapid and improved cerebellar timing circuit and related cerebellar learning mechanism pathways such as the inferior olivary-Purkinje-Thalamus cell system and other similar neuronal pools, to improve muscle memory, coordinated functional neuron-musculo-skeletal performance improvement, enhance blood flow, increased range of motion, flexibility, strength and dexterity, neuromuscular re-education, muscle tone recovery, pain modulation, improved eye-hand coordination, gait improvement, balance and stability gains, kinetic chain integration, neurological performance enhancement, sensory dysfunction reduction, and improvement in mental and cognitive function.

### CROSS-REFERENCE TO RELATED APPLICATION

To the fullest extent permitted by law, the present U.S. Non-Provisional Patent Application claims is a U.S. National Phase Filing of and with priority to Patent Cooperation Treaty Application No. PCT/US2006/018378, entitled “Frequency Stimulation Trainer,” filed on behalf of inventor Thomas E. Grant, Jr, and applicant Stimtrainer, Inc. on May 11, 2006, which claims priority to and the benefit of United States Provisional patent application entitled “Electronic Apparatus for Improving Sports Performance,” filed on May 12, 2005, on behalf of inventor Thomas E. Grant Jr., and having assigned Ser. No. 60/679,865.

### FIELD OF THE INVENTION

The present invention relates generally to neuronal cell circuit stimulator devices and methods for enhancing bodily functions and, more specifically, to a portable, body-worn, vibration/acoustic-generating, frequency stimulation trainer that encourages development of rapid and improved neuronal cell function, including cell memory via delivery of pre-timed, varying frequency vibrative and/or harmonic stimulus to sensory receptors, mechanoreceptors, proprioceptive receptors and/or pressure-sensitive nerve endings, functioning upon such systems as the olivary-pukingje-thalamus complex and similar neuronal cell circuit systems within the brain, spinal cord central nervous systems and the distributive networks thereby delivering functional improvements including but not limited to stability, dexterity, flexibility, balance, strength, proprioception, mental acuity, cognitive thinking, and delivering training and healing benefits to a user by enhancing blood flow, dampening pain receptor firing, eliciting safe and balanced stretching and toning of muscle and connective tissue, aiding in hand/eye coordination, improving the body's ability to move and perform, and aiding in gait coordination, mental concentration, muscle activation, sensory enhancement, mental acuity, kinetic chain synergy, and pain modulation, thereby enabling the relearning of functions and increasing inhibitory learning and relearning processes of the body.

The present invention is particularly suited for, although not limited to, medical rehabilitation, health preventive activities, and accelerated, assistive recuperative therapy, as well as for enhancing sports performance in athletes by engaging stability, increasing muscle tone and memory, warming muscles, and increasing flexibility, thereby decreasing injury and reducing pain. Many other applications and benefits may be realized from the present invention, including but not limited to (1) improvement in regulated gait and stabilized stance, (2) decreased dysfunctions of the body following inappropriate neuromuscular function, (3) improvement of dysfunctions of the circulatory system that cause muscular tone imbalance and tightness, (4) decreased muscle spasms and tonal imbalance, (5) improvement in musculo-vision from weakness of muscle function and in speech from muscular firing mechanism dysfunction and muscular imbalance; and further, in addition to such regulating of excessive neuro-musculo-skeletal sensory input to the central nervous system, (6) assistance with learning disabilities, (7) influenced appetite, and (8) increased vocal range.

Further, it is envisioned that the present invention could be utilized and/or adapted for utilization on other animals, such as horses, dogs, and cats, for example.

### BACKGROUND OF THE INVENTION

Studies have clearly demonstrated and documented the effects of pain due to loss of muscle tone, muscle mass, and muscle strain due to exertion, in the general population as well as athletes. Pain, which often accompanies less than optimal muscle conditioning, limits the effectiveness of stretching and training sessions. Thus, common range of motion limitations and dysfunctional muscle operations disallow an increase in tissue elasticity, increased range of motion and improved muscle coordination. Additionally, age-related decreases in physical activity, reduction in sex hormones, and decrease in nerve firing rates have been linked to strength loss, muscle atrophy, and delayed muscle response. The latter can predispose the elderly, especially women, to falls and fractures, with subsequent morbidity and mortality. It is clear, therefore, that existing problems have been well-defined and call for an effective solution.

So, too, has it been well recognized that vibration can be utilized to assist in improving physical performance, wherein vibration has been reported as capable of activating portions of the brain, including the supplementary motor area, the caudal cingulated motor area, Broadman's area 4a, the Limbic system, the Inferior Olivary-Purkinje Complex, the Thalamus, and related Cerebellar learning mechanisms. Such physiological stimulation differs from described electrical impulse stimulation of muscles and also from mechanical vibrations applied directly to a muscle or tendon, wherein direct muscle application often yields a reflex muscle contraction. This reflex response to tonic vibration is believed to be facilitated by activation of high-threshold motor units affecting fast-twitch fibers, which play a role in muscle strength and power, wherein the major part of the gain in strength is believed to be due to muscle activity provoked by vibration.

Nonetheless, tonic or direct application of vibration has been recognized as a safe mechanism, capable of delivering an anesthetic benefit, or analgesic effect, “for individuals undergoing injections of botulinum toxin type A treatment for hyperhidrosis (applied at 5700 vibrations per minute at 95 Hz), injection of filler substances such as RESTYLANE and JUVEDERM, laser therapy for leg veins, nail-fold injections, Q-switched laser treatment of tattoos, incision and drainage of abscesses (applied at 9000 vibrations per minute at 150 Hz), and cautery of facial warts, as well as facilitating anesthetic injections for needle-phobic patients.” Dermatol. Online J., 10(2), 2004, Vibration Anesthesia: A Noninvasive Method of Reducing Discomfort Prior to Dermatologic Procedure, Abstract. That is, it is recognized that vibration frequencies can provide direct analgesic benefit to the applied tissue, without the use of chemical (drug) suppression. As such, hand operated, lightweight traditional vibrator devices have been described for such direct application to a variety of parts of the body.

Contrast vibratory stimulation, wherein influence is directed to the central motor command, and carried via the Lemnical (dorsal column) system, one of the sensory tracts of the spinal cord. The intensity of the oscillating mechanical stimulus of vibration and acoustical delivery is determined by biomechanical parameters, including amplitude (i.e., the extent of the oscillatory motion), frequency (i.e., the rate of repetition of the oscillation cycles), and oscillation magnitude (the acceleration of the vibration). Whole-body-vibration (WBV), for example, consists of standing unloaded on a platform generating vertical sinusoidal vibration at a frequency of 2.5 to 40 Hz with amplitudes of 2.0 to 10.5 mm transmitted to the body to stimulate localized sensory receptors such as muscle spindles.

WBV has the potential to enhance muscular performance in older adults who are unwilling or unable to perform standard resistance exercises, wherein WBV, at 26 Hz, has been described as having an enhancing effect on vertical jumping ability, and one study by Delecluse and colleagues, published in the June 2003 issue of Medicine and Science in Sports and Exercise, showed increased isometric and dynamic knee-extensor strength of 16.6% and 9.0%, respectively, in previously untrained young women. Investigators have likewise noted the following: that vibrative treatment can render tissue elongation, specifically cartilaginous; that bilateral bicep curl cables vibrating at 44 Hz can offer a 7-10% enhancement of mechanical power; that vibration selected from a frequency range of 15 to 75 Hz can be useful for ulcer healing; and that low frequency vibration between 1-100 Hz is useful in combination with a thrombolysis catheter. It further appears that the duration of the vibrational event, in addition to the frequency of the vibration, is an important parameter.

Thus, a variety of vibrational delivery tools are known; however, each is disadvantageous in view of the present invention. For instance, one such tool provides a variable speed vibrating unit that is generally conformable to particular selected body regions, but is not wearable. Another device directs high amplitude, low frequency vibration to treat vascular obstructions via a generally cumbersome unit that limits each delivery session to a particular vibrational frequency, albeit selected from a range of frequencies. At least one other unit has been described with body-worn characteristics via a collar-type design that delivers a single frequency of vibration in a single direction at a fixed amplitude. Unfortunately, such frequency limitations inherently limit the potential benefits realized from such a device, wherein a plurality of frequencies have been recognized as particularly beneficial for application in certain treatments.

Still another vibration device has been described as possessing an auto-cycling capability; however, the cycling does not refer to the frequency that is being delivered, but rather to the cyclical involvement of a plurality of motor assemblies. Thus, although positive reactions have been reported in acute muscular trauma and post-operative convalescence following the use of the vibratory sequence 40/60/80/60/40 Hz with approximately 6 minutes duration per frequency, no known device is capable of automatedly delivering such a treatment, either by hand or body-worn delivery. Studies confirm the known body of knowledge regarding the therapeutic benefits of stimuli delivered via vibration. That stimulus has not heretofore been available as a portable, location specific application tool, nor has it been utilized as a personal training stimulus to enhance kinetic and neurological chain performance.

Therefore, it is readily apparent that there is a need for a device and method that is generally miniaturized for maximum portability, with controlled delivery of distinct non-electrical stimulation for wearable application to variable points on and/or about the body during training, and that enables the delivery of a pre-timed/programmed variable frequency range for treating dysfunction and pain, and for stimulating various neuronal activities, including, but not limited to, muscle activities and memory, thereby improving physical performance, as well as improving functional performance improvements to the body, the brain, to organ function, and to mental performance, thus preventing the above-discussed disadvantages.

### BRIEF SUMMARY OF THE INVENTION

Briefly described, in the preferred embodiment, the present invention overcomes the above-mentioned disadvantages and meets the recognized need for such a device, and method thereof, by offering a wearable, programmable, variable frequency generating personal training stimulus device capable of delivering pre-timed sequences of a plurality of frequencies to selected central nervous system input sites, thereby facilitating use as a location-specific applicator of a safe and therapeutically beneficial vibrative and vibrative/acoustic stimulus.

According to its major aspects and broadly stated, the present invention is a device and method for stimulating sensory receptors, mechanoreceptors, proprioceptive receptors, and/or pressure-sensitive nerve endings in order to deliver physical, mental, and neurological functional improvements and training and healing benefits by enhancing blood flow, interruptive retraining of nerve patterns, and dampening of pain receptor firing, thus eliciting safe and balanced stretching and toning of muscle and connective tissue, aiding in hand/eye coordination, and improving the body's ability to perceive, move, and perform.

More specifically, the present invention in its preferred form is a frequency stimulation trainer comprising a portable unit capable of delivering a preferred frequency blend range of approximately 5-165 Hz, preferably in a pre-timed, selectable frequency manner and without emitting electrical current into the body. The unit is designed to encourage wearability during physical training sessions, with a preferred stimulation site defined between the base of the head and the base of the neck, wherein the frequency stimulation delivered affects the central nervous system and physical body function via nerve pathways. The placement of the device is very important, wherein two other key body areas for frequency stimulation via the present device are the waist and feet.

The physiological frequency stimulation from the device can result in decreased incidence of injury, stronger muscle tissue, improved coordination of muscle groups, and enhanced personal performance by facilitating the body's ability to stretch to its natural limits, producing functionally acceptable muscles action via corrective neuronal pathway function, enhanced blood flow, dampened pain receptor firing, and tonal balance.

The device is suitable for the preferred application of relatively short training or treatment periods, during which the user moves his or her joints through ideal ranges of motion with increasing rapidity, resulting in increased efficiency and smoothness of motion, and measurable gains in motion and function, thus acting as a motion training and rehabilitation device that accelerates the development of an ideal motion skill, and decreases the time traditionally required for such development. The immediate effects can be maintained with repeated applications at specific intervals, wherein training intervals and duration may be varied, according to personal fitness or specific activity demands.

Because the device is communicating to the body through the central nervous system by way of vibration and/or vibration concurrent with acoustical stimulation for the purpose of providing functional improvements and healing benefits, as well as training benefits, it is important to recognize that a variety of applications are anticipated, such as for improvement of body dysfunctions resulting from inappropriate neuro-musculo-skeletal function (i.e. stretching to recover lost range of motion), tonal balance restoration, strength improvement, accelerated injury recovery, improvement in circulatory dysfunctions due to muscular tightness, spasms and desynchronization of muscle nerve cell firing patterns, musculo-vision dysfunctions due to weakness of muscle function, and speech dysfunctions due to muscular imbalance and muscular firing mechanism dysfunction. Further, in addition to its ability to influence physical performance, the device is also functionally suitable for application in treatment of central nervous system communication dysfunctions such as, for exemplary purposes only, learning disabilities, fatigue, and inappropriate appetite manifestations, as well as for potential enhancement of memorization and recall of facts, figures, sights and sounds, thus facilitating improvement in sensory function, mental processing, and cognitive function.

Accordingly, a feature and advantage of the present invention is its ability to provide multi-source harmonic stimulus in varying degrees of frequency and timing to improve neuronal cell function and neuronal cell circuit activation to enhance sports performance training, improve functional performance, re-educate neuromusculature, recover muscle tone, and stabilize gait.

Another feature and advantage of the present invention is its portable nature.

Still another feature and advantage of the present invention is its ability to apply stimulation to various parts of the body, or to attach to one part of the body to relieve pain in another non-localized part of the body while being attached by various contact means, achieving same without electrical stimulation.

Still another feature and advantage of the present invention is its ability to reduce pain and enhance physical flexibility, dexterity, performance, and functional stability.

A further feature and advantage of the present invention is its ability to encourage rapid and improved cellular memory recall via delivery of pre-timed, varying frequency vibrative and/or harmonic stimulus to sensory receptors, mechanoreceptors, proprioceptive receptors, and/or pressure-sensitive nerve endings.

Still a further feature and advantage of the present invention is its ability to deliver functional improvements and training and healing benefits by enhancing blood flow, dampening pain receptor firing, retraining neuronal pool performance parameters, influencing cerebellar timing circuits, eliciting safe and balanced stretching and toning of muscle and connective tissue, aiding in hand/eye coordination, enhancing cell memory, and improving the body's ability to move and perform.

Yet another feature and advantage of the present invention is its ability to positively influence neuronal cell circuit communicative properties in the brain, central nervous system, parasympathetic, sympathetic and peripheral nerve systems, cerebellar learning mechanisms and associated cerebellar learning pathways and associated neuronal pools resulting in recovery from dysfunctions of the body following inappropriate neuro-musculo-skeletal function, recovery from dysfunctions of the circulatory system due to muscular tightness, spasms and desynchronization of muscular firing patterns, dysfunctions of musculo-vision due to weakness of muscle function, and dysfunction of speech due to muscular imbalance and muscular firing mechanism dysfunction.

Yet still another feature and advantage of the present invention is its ability to be utilized as an anesthetic, in lieu of, or in combination with chemical suppression techniques.

Yet a further feature and advantage of the present invention is its ability to enhance tissue elongation, especially cartilaginous.

Still yet a further feature and advantage of the present invention is its ability to enhance sports performance in athletes.

Still another and further feature and advantage of the present invention is its ability to influence appetite signals.

Still yet another and further feature and advantage of the present invention is its ability to stimulate an increase in vocal range.

Still another feature and advantage of the present invention is its ability assist in the treatment of learning disabilities.

Yet still a further feature and advantage of the present invention is its ability to automatedly deliver selected frequencies, amplitude, and oscillation magnitude for selected periods of duration.

Yet another and further feature and advantage of the present invention is its ability to be worn or applied to a plurality of points about the body during training and/or exercise.

Yet still another and further feature and advantage of the present invention is its ability to deliver from a broad frequency blend range in a pre-timed, selectable intensity and selectable frequency manner.

An additional feature and advantage of the present invention is its ability to perform as a motion training and rehabilitation device that accelerates the achievement of development of an ideal motion skill and improvement of neuro-musculo-skeletal functional performance.

Still an additional feature and advantage of the present invention is its ability to facilitate immediate effects, which, although temporary, can be extended and maintained with repeated applications at specific intervals.

Still yet an additional feature and advantage of the present invention is its ability to accommodate variable programmed training intervals and durations, according to personal fitness or specific activity demands.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of the frequency stimulation trainer of the present invention, according the preferred embodiment;

FIG. 2 is a perspective view of the frequency stimulation trainer of FIG. 1, showing the device in position on the neck of an individual user;

FIG. 3 is a perspective view of the frequency stimulation trainer of the present invention, according to an alternate embodiment, showing a torso-wearable configuration;

FIG. 4 is a perspective view of the frequency stimulation trainer of FIG. 3, showing the device in position on the waist of an individual user;

FIG. 5 is a perspective view of the frequency stimulation trainer of the present invention, according to an alternate embodiment, showing a shoe-insert configuration;

FIG. 6 is an overhead view of the frequency stimulation trainer of FIG. 5, showing the interior component layout;

FIG. 7 is a side view of the frequency stimulation trainer of FIG. 5;

FIG. 8 is a perspective view of the frequency stimulation trainer of the present invention, according to an alternate embodiment, showing the frequency stimulation applicator being worn on the neck of the user;

FIG. 9 is a perspective view of the frequency stimulation trainer of FIG. 8, and

FIG. 10 is a perspective view of the frequency stimulation trainer of the present invention, according to an alternate embodiment.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

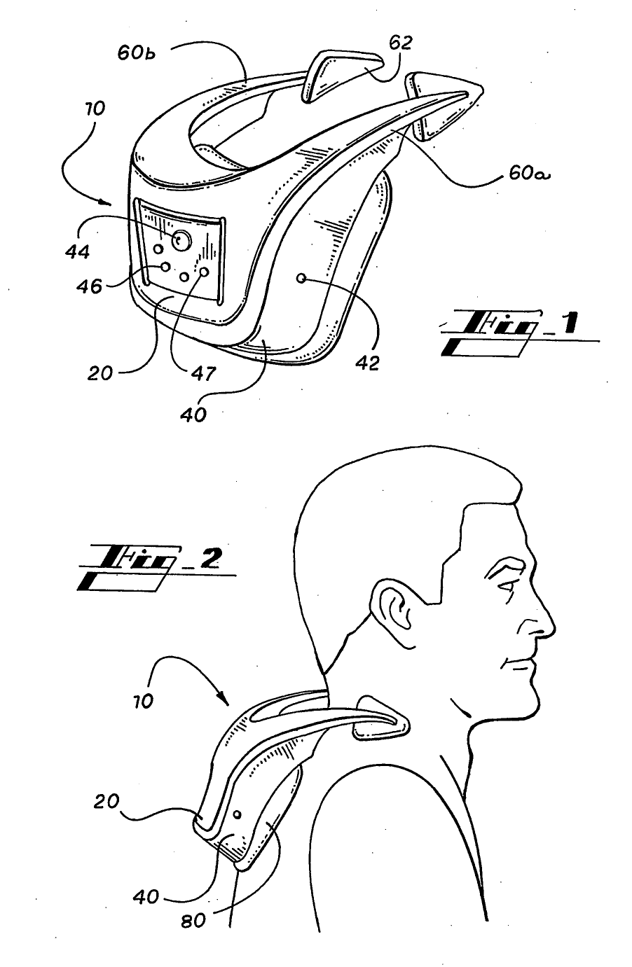

Referring now to FIG. 1, the present invention in its preferred form is frequency stimulation trainer 10, preferably defined as cervical unit 20, and comprising housing 40, support arms 60a and 60b, and stimulant applicator 80. Preferably, vibrational energy is directed to stimulant applicator 80 from within housing 40, where, therewithin, the source of vibrational energy is carried. Preferably, frequency stimulation trainer 10 operates using a vibration core, preferably set to fire at pre-selected frequencies covering a range of approximately 5-165 Hz, wherein preferably, coupled sound frequencies generated by the device blend with the vibration frequencies. Various qualities of vibrational motors or acoustical frequency generators can be used to control the output quality of the vibration/acoustical mechanism, wherein any suitable vibrational and/or acoustical force generating mechanism could be utilized. For example, an eccentric mass mechanism driven by an oscillator or acoustical frequency generator could be utilized. Vibration may also be generated via induction of low level sound frequencies through electrical conduction in a coil, wherein resulting resonances may be transferred from internal surfaces to external surfaces, resulting in a harmonic vibration of the surface materials. Another exemplary method is acquisition of vibration through direct impact in a linear, perpendicular fashion, such as a hammer striking a surface at a right angle, an obtuse angle, or variations of such angles to produce a resonating vibration effect. Further, two shaped surfaces, similar or dissimilar, can be set into motion in proximity to each other to generate vibration, such as via a wash-board effect. Additional exemplary, yet not exhaustive, methods for production of vibrational and/or acoustical forces are known to include techniques involving thermal conductance, biochemical-to-biomechanical influences, and/or wind introduction, wherein any suitable method may be adapted for use in frequency stimulation trainer 10.

Preferably, frequency stimulation trainer 10 is battery operated, however, an AC power input adapter and suitable connection could also be provided as a direct power source, or as a rechargeable power source, wherein on/off switch 42 is preferably defined on housing 40. Preferably, frequency stimulation trainer 10 is adapted to operate and deliver at a preferred frequency range of approximately 5 to 165 Hz; however, one skilled in the art would recognize that frequency functionality outside of such a range would not depart from the intended scope of the present invention. Further, frequency functionality more limited than the preferred range could also be a feature of the present invention, wherein programmable varied frequency sessions within the available range could offer an improvement over previous options. Preferably, housing 40 also includes frequency selector 44, time/duration/oscillator/oscillatory magnitude selector 46, and status indicator 47 to convey operational functions.

Preferably, stimulant applicator 80 of frequency stimulation trainer 10 is adapted with a plurality of stimulation sites (not shown) designed with preferred materials that maintain the selected frequencies, and that, when properly positioned relative to the spine and/or extremities of the user, facilitate the delivery of a pre-selected, or programmed frequency series. Such proper placement and retention of frequency stimulation trainer 10 on the neck of a user is preferably assisted via support arms 60a and 60b, and contact surface 80, wherein the preferred generally arcuately-shaped configuration of support arms 60a and 60b facilitates a hugging of the neck, and wherein each support arm 60a and 60b preferably extends to a position proximate the side neck of the user in order to facilitate retention of frequency stimulation trainer 10 during user movements. It is envisioned that inner surface 62 of support arms 60a and 60b could be treated with a non-skid, gripping surface treatment, or could be padded, or otherwise adapted to enhance retentive abilities and/or user comfort while maintaining at least tolerable skin contact with suitable skin-tolerant materials.

The preferred positioning of frequency stimulation trainer 10 facilitates delivery of stimulation to the central nervous system in order to facilitate rapid and improved cerebellar timing circuit and related cerebellar learning mechanism pathways, such as the inferior olivary-Purkinje-Thalamus cell system, sympathetic and parasympathetic nervous systems, and other similar neuronal pools. The preferred lightweight nature of device 10 enhances the desirability of body-worn use in the preferred position between the base of the head and the base of the neck, where maximized effect may be realized. It is important to note, however, that device 10 may be worn on the neck, at the base of the skull, on the shoulders, on the hips, or worn, attached, or applied to essentially any joint and/or neurosynaptic rich junction of the body, including the feet.

Preferably, via frequency selector 44 and time/duration/oscillator/oscillatory magnitude selector 46, a desired stimulus may be programmed by a user, wherein the stimulus may preferably be -selected from (1) a single time period for delivery of a single particular frequency, (2) a repetitive period of singular duration for delivery of a single particular frequency, (3) a repetitive period of singular duration for delivery of a plurality of frequencies in a given order, (4) a plurality of periods of duration for delivery of a single particular frequency, (5) a plurality of periods of duration for delivery of a plurality of frequencies, or (6) a non-timed delivery of a selected frequency or frequencies. In such a manner, frequency stimulation trainer 10 preferably provides a selectable pre-timed, varying frequency vibration/harmonic stimulus, wherein training intervals, duration, and frequency may vary according to personal fitness or specific activity demands. Additionally, any combination or permutation of the foregoing stimulus patterns may be employed, as desired.

The frequency stimulation trainer 10 of the present invention has been shown to provide a great effect on selected areas of concentrated sensory receptors (such as vibration, audio, and proprioceptor), mechanoreceptors, and pressure sensitive nerve endings, although many other known nerve fibers can carry frequency signal stimulation. The nerve pattern interrupt/dampening/enhancement effects of device 10 allow for an increase of strength, tonal coordination and strengthening of the working tissue, thus providing freer motion of the body's tissue (muscle, tendon, ligament and connective tissue) without incurring injury to the area(s) being worked. The foregoing is accomplished through excitation and inhibition of the inferior olivary-Purkinje-Thalamus system, thereby influencing enhanced blood flow (stimulation of blood vessel nerves leads to increased blood flow, and muscle toning leads to warming of the tissue, enhancing the effects of stretching, exercising and training), dampened pain receptor firing and muscle tone balance, wherein device 10 permits measurable performance gains in the areas of physiologic motion and function and enhances performance outcomes. Moreover, the unique strategic treatment delivery options supported by frequency stimulation trainer 10, via the programmable frequency selection and duration, enhance the benefits derived therefrom.

Frequency stimulation trainer 10 is preferably capable of performing in a variety of modes, as noted hereinabove, wherein such operational flexibility is particularly suitable for healthcare applications. Other performance options are envisioned, including more limited modal selection, such as fewer than six modes, wherein such limited options could be particularly suitable for certain particular sports, therapeutic, and functional performance applications, and further such as greater than six modes exemplarily for use in professional and healthcare specific applications.

Frequency stimulation trainer 10 is preferably manufactured with desired coloration preferably related to targeted end users. For example, healthcare models could carry a white coloration recognizable by many as a traditional medical tool appearance; sports models could carry team logos and/or coloration, titanium, and/or chrome embellishments; educational use models could carry a recognizable purple coloration; general use retailed models could carry distinctive royal blue coloration; industrial models could carry a safety yellow coloration with black accents; and military models could carry a camouflage and/or black coloration, or other specified colors or color combinations suitable to a specified use or environment. It is anticipated that the present invention, in any or all embodiments, could include visual effects, coloration, and/or ornamentation, such as, but not limited to, reflective ornamentation, distinctive or glow-in-the-dark coloration, insignias, mascot depictions, licensed characters, and/or any combination thereof.

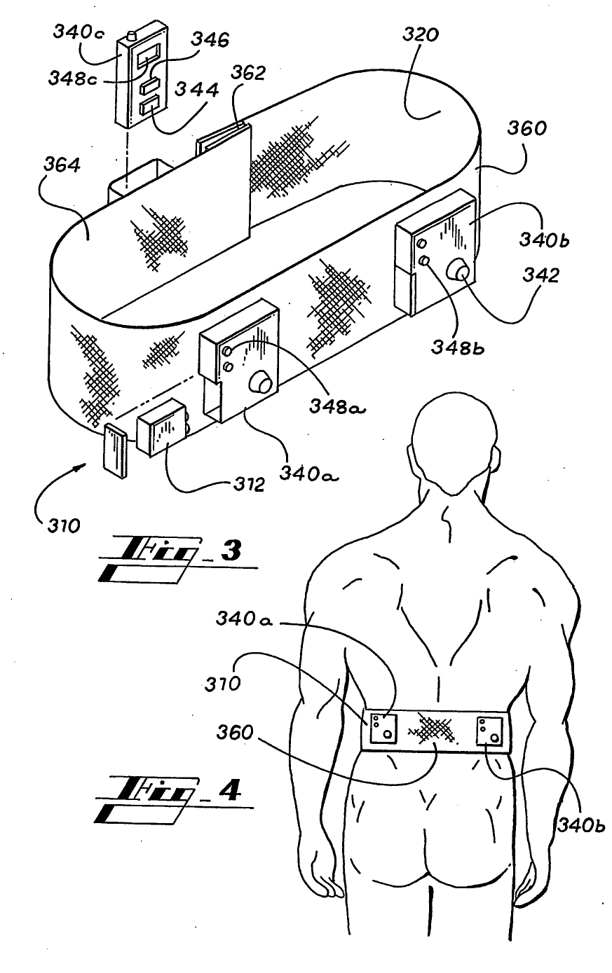

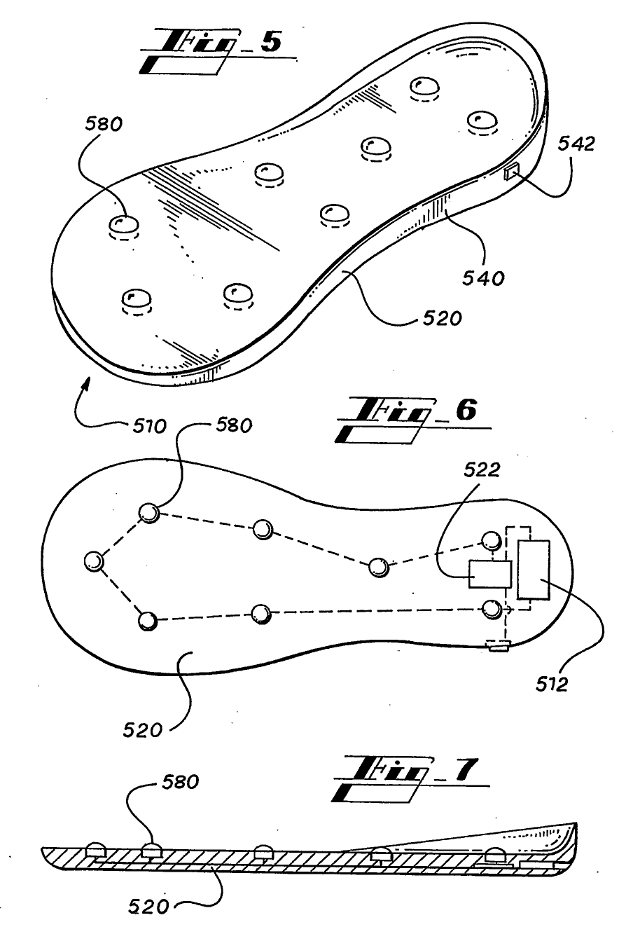

It is important to understand that the present invention is suitable for adaptation and utilization according to a variety of forms, such as with exemplary alternate configurations depicted in FIGS. 3-9, wherein varied nerve pathways may be utilized, via varied device configurations, for delivery of the stimulation to the central nervous system and muscles related neuronal cell systems influenced by such stimulation, such as skeletal muscle, smooth muscle, sympathetic and parasympathetic nervous systems, and neuronal pools. Thus, the vibrational and acoustic stimulation functional delivery throughout the body's neuronal communication system may also be accomplished via alternate wearable units 310 and 510 to the torso or waist, respectively, or to the feet via placement into shoes in lieu of being worn on the neck.

Referring to FIGS. 3-4, wearable unit 310 is defined as torso unit 320, comprising plurality of housings 340a, 340b and 340c, belt support 360, and plurality of stimulant applicators 380 (not shown). Vibrational and the resultant acoustical energy forces are directed to plurality of stimulant applicators from within housings 340a and 340b, where, therewithin, a source of vibrational, in combination with acoustical, energy force is carried. As with the preferred embodiment, wearable unit 310 operates using a frequency stimulation core, preferably set to fire at pre-selected frequencies covering a range of approximately 5-165 Hz, wherein any suitable frequency force generating mechanism could be utilized.

Frequency stimulation trainer wearable unit 310 is operated via battery 312, however, an AC power input adapter and suitable connection could also be provided as a direct power source, or as a rechargeable power source, wherein on/off switch 342 is preferably defined on each housing 340a and 340b. Housing 340c also includes frequency selector 344, time/duration/oscillator/oscillatory magnitude selector switch 346, and plurality of status indicators 348a, 348b and 348c to convey operational functions.

Plurality of stimulant applicators 380 of frequency stimulation trainer wearable unit 310 are adapted with a plurality of stimulation sites (not shown) designed with materials that maintain the selected frequencies, and that, when properly positioned on the user, facilitate the delivery of a pre-selected, or programmed frequency series. Such proper placement and retention of frequency stimulation trainer wearable unit 310 on the waist of a user is assisted via belt support 360, wherein cooperative fastener 362, such as hook-and-loop fastener, facilitates a hugging of the waist, and wherein belt support 360 extends about the waist to direct plurality of stimulant applicators 380 into position, and in order to facilitate retention of frequency stimulation trainer wearable unit 310 during user movements. It is envisioned that inner surface 364 of belt support 360 could be padded, or otherwise adapted to enhance retentive abilities and/or user comfort.

As with the preferred configuration of frequency stimulation trainer 10, alternate wearable unit 310 provides a selectable pre-timed, varying frequency vibration/harmonic stimulus, wherein training intervals, duration, and frequency may vary according to personal fitness or specific activity demands.

Referring now to FIGS. 5-7, wearable unit 510 is defined as shoe insert unit 520, comprising plurality of innersole housing 540, and one or more stimulant applicator(s) 580 positioned preferably singularly at various positions, or alternately in specific combinations together, or targeted groupings. Frequency stimulation energy forces are directed to a plurality of stimulant applicators 580 from within innersole housings 540, where, therewithin, a source of frequency stimulation energy 522 is also carried. As with the preferred embodiment, wearable unit 510 operates using a frequency stimulation, preferably set to fire at pre-selected frequencies covering a range of approximately 5-165 Hz, wherein any suitable frequency stimulation generating mechanism could be utilized.

Frequency stimulation trainer wearable unit 510 is operated via battery 512, however, an AC power input adapter and suitable connection could also be provided as a direct power source, or as a rechargeable power source, wherein on/off switch 542 is preferably defined on innersole housing 540. Innersole housing 340 also includes frequency selector (not shown), time/duration/oscillator/oscillatory magnitude selector switch (not shown), and status indicator (not shown) to convey operational functions. Remotely controlled options could also be employed.

Plurality of stimulant applicators 580 of frequency stimulation trainer wearable unit 510 are adapted with stimulation sites (not shown) designed with materials that maintain the selected frequencies, and that, when properly positioned on the user, facilitate the delivery of a pre-selected, or programmed frequency series. Such proper placement and retention of frequency stimulation trainer wearable unit 510 proximate the foot of a user facilitates a hugging of the foot to direct plurality of stimulant applicators 580 into position, and in order to facilitate retention of frequency stimulation trainer wearable unit 510 during user movements. It is envisioned that innersole housing 540 could be padded, or otherwise adapted to enhance user comfort.

As with the preferred configuration of frequency stimulation trainer 10, alternate wearable unit 510 provides a selectable pre-timed, varying frequency vibration/harmonic stimulus, wherein training intervals, duration, and frequency may vary according to personal fitness or specific activity demands. Further, it is envisioned that alternate wearable unit 510, or any other model of frequency stimulation trainer 10, could also incorporate a device feedback response technology, wherein the frequency stimulation could be modified for peak unit performance.

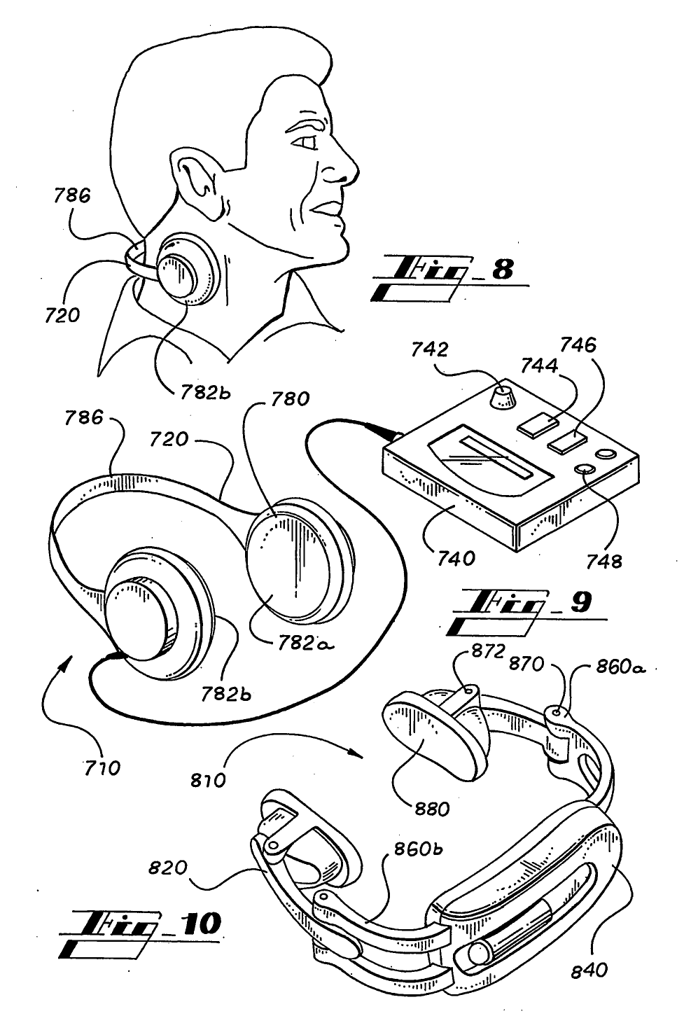

Referring now to FIGS. 8-9, alternate frequency stimulation trainer device 710 includes base unit housing 740 for generating the aforementioned frequency characteristics, and wearable unit 720 capable of delivering the vibrational/harmonic stimulation to the body. Base unit housing 740 is variably sized, from that similar to a pager, to a miniature handheld cassette recorder, and to a larger, disabled-user-friendly size, to facilitate portability, and may be battery operated or powered by any suitable source, rechargeable or otherwise. Base unit housing 740 is a multiple frequency generation device capable of delivering a frequency blend range in a pre-timed, selectable frequency manner, as further described hereinabove with respect to the preferred embodiment. Wearable unit 720 functions as stimulant applicator 780, via pads 782a and 782b, and is worn between the base of the head and the base of the neck, as depicted in FIG. 8, wherein wearable unit 720, including pads 782a and 782b, is sized and configured with an appearance much like traditional acoustical headphones. The resilient nature of applicator support 786 for frequency stimulation trainer 710, like that of a traditional headphone support, assists in securing wearable unit 720 on the wearer, that is, to the neck, wherein the frequency stimulation is delivered to the user's body via pads 782a and 782b, with concurrent transfer of combined vibroacoustical properties through the auditory pathway.

Base unit housing 740 is operated via battery (not shown), however, an AC power input adapter and suitable connection could also be provided as a direct power source, or as a rechargeable power source, wherein on/off switch 742 is preferably defined on housing 740. Housing 740 also includes frequency selector 744, time/duration/oscillator/oscillatory magnitude selector switch 746, and plurality of status indicators 748 to convey operational functions. As with the preferred configuration of frequency stimulation trainer 10, alternate unit 710 provides a selectable pre-timed, varying frequency vibration/harmonic/acoustic stimulus, wherein training intervals, duration, and frequency may vary according to personal fitness or specific activity demands. Remotely controlled options could also be employed.

Referring now to FIG. 10, alternate configuration 810 is defined as cervical unit 820, and comprising housing 840, support arms 860a and 860b, and stimulant applicator 880. Alternate cervical unit 820 is generally configured and operates essentially the same as preferred cervical unit 10 relative to the delivery of frequencies; however, support arms 860a and 860b of cervical unit 820 include hinges 870 and 872 in order to facilitate adjustability, snug fit, and compact and easy transport.

For example, in use, if an individual seeks to improve muscle memory recall and/or hand/eye coordination, or to elicit rapid and safe stretching of muscle and connective tissue, frequency stimulation trainer 10 is preferably placed on the body and utilized through relatively short training periods, either self-directed (with or without viewing a training tape) or with the help of another person (i.e., coach, trainer, or physician), wherein during each training period, the user is assisted, via the stimulation, while more rapidly moving his or her joints through ideal ranges of motion. After just minutes of this routine, the user's abilities are enhanced, wherein the motions can be repeated more efficiently and smoothly. Similar outcomes are experienced in enhanced recovery from injury, rehabilitation of disabled persons and enhanced performance or a plurality of fitness, work place, military, commercial and similar conditions requiring performance improvement.

Depending upon the embodiment selected, that is, the body area to receive the frequency stimulational input, a user will preferably select either cervical unit 20, torso unit 320, shoe insert unit 520, or wearable unit 720. For example, data has been collected that indicates that frequency stimulation applied to the feet can assist in the restoration of balance to those who are thusly challenged. Further, depending upon the goal of the training or treatment, and/or the need for reduction of pain experienced through dysfunction, injury, neuropathy or surgery, the user will preferably select a first frequency stimulational frequency to be delivered and a duration for the period of stimulation. If the user desires to undergo a series of stimulation periods, the user can select subsequent durations for stimulation periods at the same initial frequency, or, if desired, the user can select a second frequency and a duration therefore, a third frequency and a duration therefore, and so on.

This programmable flexibility enables use of frequency stimulation trainer 10 in a plurality of environments, such as, by way of example without limitation, sports, healthcare, military, industrial safety and training, and transport vehicle operation, in order to accomplish a wide variety of tasks, such as, again without limitation, 1) training employees in the work place to prevent overuse injury syndromes; 2) improving functional disabilities, from walking to talking to visual and sensory dysfunctions, such as in those individuals suffering with cognitive, neurological and biochemical disorders, and the like; 3) providing direct analgesic benefit to applied tissue, with or without the use of chemical (drug) suppression; 4) assisting with rehabilitation via tissue elongation, muscle strength increase, and muscle toning without incurring injury to the area being treated; 5) facilitating the body's ability to stretch to its natural physiological limits; 6) strengthening muscle tissue, decreasing injury, improving coordination of muscle groups and enhancing personal performance via training for muscle coordination, function and development of interdependent companion muscle tissue and smoother, high-level muscle-motor control; 7) improving circulation of body fluids; 8) affecting appetite signals; 9) assisting with chronic pain relief; 10) improving diminished or lost sensory feelings in the extremities; and 11) enhancing memorization and recall of facts, figures, sights and sounds.

In clinical experiments and evaluation trials, the frequency stimulation trainer 10 of the present invention reportedly had the following effects on participants: 1) substantial stretching increases within 30-60 seconds (forward bending); 2) increases in range of motion; 3) decreases in time required to rehabilitate joints after injury; 4) quick warming of muscles prior to work or competition; 5) betterment of personal records in athletic competition; 6) decreased pain after muscle strain; 7) increased tone and pitch of singing voices; 8) improved hand/eye coordination; 9) gave athletes a feeling of having the competitive edge without drugs; 10) improved muscle memory recall; 11) improved gait following injury; 12) reduced sensory dysfunctions; 13) improved mental and cognitive functions; 14) re-educated neuromusculature; 15) aided a stroke victim in gaining improved control over extremities; 16) improved visual acuity; and 17) decreased muscle spasms such as acute torticollis.

Although applications and uses of the vibrational and/or acoustical frequency stimulation trainer 10 could be essentially unlimited, specifically indicated and anticipated uses for athletes engaging in particular sports include the following: 1) Golf—Device 10 can be utilized to stretch and warm-up muscles quickly, improving muscle memory recall, enhancing swing mechanics and increasing hand/eye coordination; 2) Baseball/Tennis—Device 10 can help prevent muscle pulls and bring such injury to quicker resolution; 3) Basketball—Device 10 can, and has, helped players jump higher, warm-up muscles faster for competition, and enable injured players to return to game play more quickly; and 4) Running—Device 10 can benefit sprint/mid-distance and long distance runners by accomplishing quick warm-up, stretch and ideal motion stride training.

The healthcare field could also realize specific benefits from use of Device 10, such as: improved neuromuscular re-education outcomes, accelerated disability recovery, functional performance improvement, coordinated musculoskeletal conditioning, improved recovery of sensory dysfunctions, kinetic chain integration and neurological performance enhancement.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A method for influencing neuronal pools and cell circuit pathways and mechanisms resulting in functional changes to neuronal communication systems to influence physical function, mental function, reduce pain, enhance motion and stability, comprising the steps of:
a) obtaining a programmable device adapted for delivery of a plurality of selectable stimulation frequencies to the body, wherein each said selected stimulation frequency of said plurality of selectable stimulation frequencies is automatedly delivered for a period of stimulation duration selected from a plurality of periods of frequency stimulation duration;
b) applying said device to the body for a first treatment period; and
c) moving the body through a selected functional improvement procedure during said first treatment period.

2. (canceled)

3. The method of claim 1, further comprising the steps of:
d) applying said device to the body for a second treatment period;
e) moving the body through a selected functional improvement procedure during said second treatment period;
f) observing differences in the functional improvement between said first treatment period and said second treatment period; and
g) selectively repeating steps d, e, and f until said differences in the functional improvement are acceptable.

4. A method of improving corrective participative action of neuronal cell circuits and cell memory performance, comprising the steps of:
a) obtaining a device suitable for automated, pre-timed delivery of vibro-acoustic sequence of varying frequency harmonic stimuli to a selected body region;
b) positioning said device proximate to an influential access point of selected nervous system receptors; and
c) delivering said vibro-acoustic sequence.

5. The method of claim 4, wherein said nervous system receptors are selected from the group consisting of: sensory receptors, mechanoreceptors, and pressure-sensitive nerve endings.

6. The method of claim 4, wherein said selected body region is selected from the group consisting of: a region between the base of the head and the base of the neck, a region proximate the waist and a region proximate the bottom of the foot.

7. (canceled)

8. (canceled)

9. The method of claim 4, wherein said automated, pre-timed delivery of vibro-acoustic sequence of varying frequency harmonic stimuli is selected from the group consisting of a single time period for delivery of a single particular frequency range, a repetitive period of singular duration for delivery of a single particular frequency range, a repetitive period of singular duration for delivery of a plurality of frequencies in a given order, a plurality of periods of duration for delivery of a single particular frequency range, a plurality of periods of duration for delivery of a plurality of frequencies, or a non-timed delivery of a selected frequency range.

10. A portable, frequency-generating stimulant trainer, comprising:
means for delivering pre-timed sequences of a plurality of frequencies to selected central nervous system input sites on the body;
at least one portable housing; and
a power source.

11. The portable, frequency-generating stimulant trainer of claim 10, wherein said stimulant trainer generates non-electrical stimulation frequency.

12. The portable, frequency-generating stimulant trainer of claim 10, wherein said trainer is wearable.

13. The portable, frequency-generating stimulant trainer of claim 10, wherein said wearable trainer is a cervical unit.

14. The portable, frequency-generating stimulant trainer of claim 13, wherein said cervical unit further comprises a plurality of support arms and wherein a user-contact surface of said cervical unit further comprises surface treatment selected from the group consisting of non-skid surface treatment or padding.

15. The portable, frequency-generating stimulant trainer of claim 12, wherein said wearable trainer is a torso unit further comprising a plurality of housings carried by a belt support, and a belt fastener.

16. (canceled)

17. The portable, stimulation frequency-generating stimulant trainer of claim 12, wherein said wearable trainer comprises an insole unit further comprising a plurality of innersole carried housings and a plurality of stimulant applicators.

18. (canceled)

19. A bodyworn personal training stimulus, comprising:
means for generating a plurality of non-electrical stimulation frequencies from a frequency range;
means for delivering to the body individually selectable frequency stimuli from said frequency range;
means for controlling the period of time during which each said frequency stimuli is delivered to the body;
and
a frequency selector for selecting said frequency stimuli and magnitude thereof for delivery.

20. The bodyworn personal training stimulus of claim 19, further comprising:
a housing;
a power source; and
a power switch, said switch carried on said housing, said amplitude/frequency/oscillation magnitude selector carried by said housing, said means for generating said plurality of non-electrical stimulation frequencies carried within said housing, and said means for controlling the period of time during which each said frequency stimuli is delivered to the body carried by said housing.

21. The bodyworn personal training stimulus of claim 19, wherein said frequency range is approximately 5 to 165 Hertz.

22. (canceled)

23. The bodyworn personal training stimulus of claim 19, wherein said means for generating a plurality of stimulation frequencies is selected from the group consisting of an eccentric mass mechanism driven by an oscillator, an acoustical frequency generator, low level sound frequency induction, direct linear surface impact dual-surface motion techniques, thermal conductance techniques, application of biochemical-to-biomechanical influences or wind introduction.

24. (canceled)

25. (canceled)

26. The bodyworn personal training stimulus of claim 20, further comprising an AC power input adapter, wherein said power source is external.

27. The bodyworn personal training stimulus of claim 19, wherein said means for controlling the period of time during which each said non-electrical frequency stimuli is delivered to the body comprises a duration selector source.

28. (canceled)

29. The bodyworn personal training stimulus device of claim 14, wherein said stimulant applicator further comprises a plurality of stimulation sites.

30. The bodyworn personal training stimulus device of claim 20, further comprising application-targeted coloration.

31. The bodyworn personal training stimulus of claim 20, wherein said housing defines a shoe innersole, said shoe innersole carrying said means for generating a plurality of non-electrical stimulation frequencies from a frequency range, said means for delivering to the body individually selectable frequency stimuli from said frequency range, said means for controlling the period of time during which each said frequency stimuli is delivered to the body, said power source, said power switch, and said frequency selector.

32. (canceled)

33. (canceled)

34. The portable, frequency-generating stimulant trainer of claim 12, wherein said wearable trainer comprises a shoe unit, and wherein said shoe unit further comprises a plurality of innersole carried housings and a plurality of stimulant applicators.

35. The bodyworn personal training stimulus of claim 20, wherein said housing and said means for delivering to the body individually selectable non-electrical frequency stimuli from said frequency range are wirelessly related.

36. The portable, frequency-generating stimulant trainer of claim 13, wherein said cervical unit further comprises a plurality of hinges.
